(19) United States
(12) Patent Application Publication
(10) Pub. No.: US 2005/0099312 A1
(43) Pub. Date: May 12, 2005

(54) Smoke detector with battery pack

(76) Inventor: Francis Paul Blanche, Pompton Lakes, NJ (US)

Correspondence Address: FRANCIS PAUL BLANCHE;APT. 511, 625 HAMBURG TURNPIKE, POMPTON LAKES, NJ, 07442, US

(21) Appl. No.: 10/703,974

(22) Filed: Nov. 10, 2003

(51) Int. Cl. G08B 17/10

(52) U.S. Cl. 340/628; 340/693.5; 340/514

(57) ABSTRACT

The addition of wiring from Smoke Detector and the addition of a Battery Pack connected to the Smoke Detector by the wiring is a design change over existing Smoke Detectors. This is different in that it removes the batteries and testing button from the main body of the Detectors

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

Need to improve current Smoke Detectors, by enhancing the ability of persons to test and change batteries when needed. It makes access to both testing and batteries easier.

### BRIEF SUMMARY OF THE INVENTION

Smoke Detector with the addition of an accessible Battery Pack that can be mounted on the wall. Battery Pack is connected to Smoke Detector using flat wiring which is sticky on one side. This allows for Battery Pack to be mounted at height accessible by those unable or unwilling to get to higher mounted body of detector.

Additionally the small testing button associated with most in-home Smoke Detectors is mounted on Battery Pack. This allows for testing from same safe position.

### BRIEF DESCRIPTION OF THE SEVERAL VIEWS OF THE DRAWING

FIG. 1A—drawing of SMOKE DETECTOR WITH BATTERY PACK

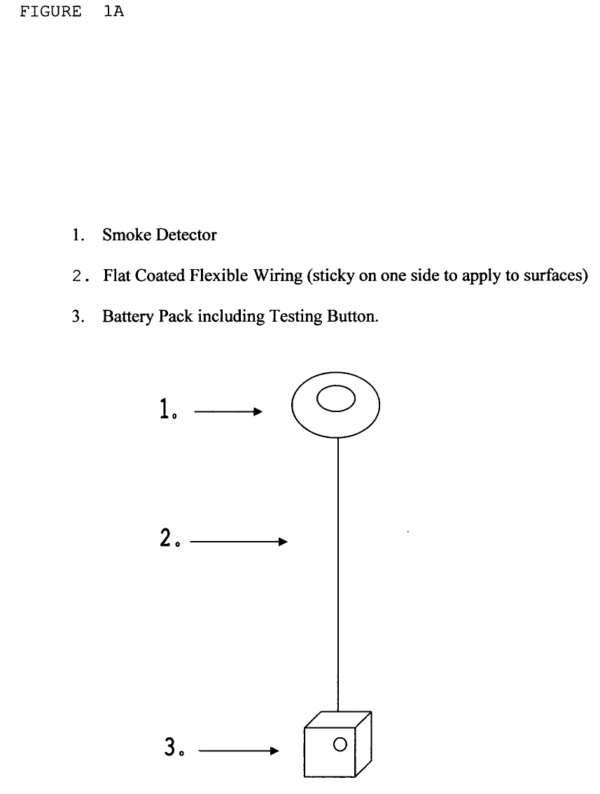

### DETAILED DESCRIPTION OF THE INVENTION

Smoke Detector unit without batteries enclosed within the actual detector itself. The batteries have been relocated to a Battery Pack outside of the detector. The new Battery Pack includes the Testing Button found on Detectors commonly used to test if working.

The Batter Pack is attached to the Detector using flexible wiring that is encased and has a sticky backing. The backing lets the wiring be attached to surfaces allowing the Battery Pack to be mounted in an accessible area. The wiring is flat to be as unobtrusive as possible.

This is a new type of Smoke Detector that has to be manufactured, it is not a retrofitting device.

1. A newly designed Smoke Detector that allows for the easier access by disabled and elderly, and other interested persons, to both the batteries and the testing button(s). It is different than existing Smoke Detectors in that the batteries and the testing button can now be mounted in a convenient place. For example, a wall.
This new design is a change to existing battery powered Smoke Detectors because it moves the batteries and testing button to a more accessible place.
